(19) United States
(12) Patent Application Publication
(10) Pub. No.: US 2008/0273896 A1
(43) Pub. Date: Nov. 6, 2008

(54) IMAGE FORMING APPARATUS AND IMAGE FORMING METHOD

(76) Inventor: Izumi Kinoshita, Hyogo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/105,009

(22) Filed: Apr. 17, 2008

(30) Foreign Application Priority Data
May 2, 2007 (JP) 2007-121893

(51) Int. Cl. G03G 15/01

(52) U.S. Cl. 399/151

(57) ABSTRACT

A light source emits a light beam for forming an electrostatic latent image on a plurality of image carriers charged by a charging unit. A polygon mirror deflects the light beam from the light source in a main scanning direction. A developing unit develops the electrostatic latent image formed on the image carriers with a developer to obtain a visible image. A fixing unit fixes the visible image transferred onto the recording medium by a transfer unit. The polygon mirror includes four reflection planes with different tilt angles with respect to a rotation axis of the polygon mirror. The control unit includes a correction unit that performs an fθ correction.

### CROSS-REFERENCE TO RELATED APPLICATIONS

The present application claims priority to and incorporates by reference the entire contents of Japanese priority document 2007-121893 filed in Japan on May 2, 2007.

### BACKGROUND OF THE INVENTION

1. Field of the Invention

The present invention relates to an image forming apparatus for forming a color image using an electrophotographic technology, and more particularly, to an image forming apparatus for forming an image through raster scanning using a polygon mirror that includes reflection planes having various tilt angles.

2. Description of the Related Art

Most of conventional color electrophotographic apparatuses including a plurality of photosensitive elements have a tandem structure as shown in FIGS. 8 and 9. In the tandem structure, each images of black (K), yellow (Y), magenta (M), and cyan (C) is formed on an intermediate transfer belt. Therefore, a light source is required for each of the four colors, i.e., at least four laser diodes (LDs) and control units for controlling the LDs are required. A light emitted from an LD is deflected by a polygon mirror, and is projected onto a photosensitive element of corresponding color. The photosensitive element is raster-scanned with the light deflected in accordance with rotation of the polygon mirror. The scanning in the direction of the raster scan is called “main scanning”.

The main scanning is a constant angular velocity scanning because the polygon mirror rotates at a constant angular velocity. In the constant angular velocity scanning, a scanning speed at which the photosensitive element is scanned is inconstant. If an exposure period of each pixel is adjusted to a constant value, a length of each pixel becomes various. To obtain an equal pixel length, it is necessary to obtain a constant scanning speed in the main scanning direction by performing an fθ correction. The fθ correction is performed using an fθ lens. Each photosensitive element is raster-scanned by using all reflection planes of the polygon mirror. However, a reflection angle of each of the reflection planes is required to be corrected because the reflection angles may be unequal due to production tolerance or the like. This correction is called as an optical face tangle error correction. The optical face tangle error correction is performed using the fθ lens. The fθ lens is basically an expensive element. Although low-cost plastic fθ lenses are available, the plastic fθ lenses are inferior in temperature characteristics or optical characteristics.

Synchronous detection is performed to adjust a write-starting position in the main scanning. A synchronous detecting sensor for the synchronous detection is required to be arranged in an area other than an image writing area, which reduces a ratio of the image writing area against one raster scanning (hereinafter, “effective scanning-period ratio”). The effective scanning-period ratio is calculated by

Effective scanning-period ratio=image writing area/raster-scanning area =(number of writing dots/writing frequency)/(time required for a single rotation of the polygon mirror/number of faces of the polygon mirror)

The (time required for a single rotation of the polygon mirror/number of faces of the polygon mirror) depends on a sub-scanning resolution and a linear speed in the sub-scanning direction, and the number of writing dots depends on a width of the image writing area in the main scanning direction and a main-scanning resolution. Therefore, if the effective scanning-period ratio decreases, it is required to increase the writing frequency. Given below are examples of conventional technologies about a scanning polygon mirror.

Japanese Patent Application Laid-open No. 2003-266785 discloses an image forming apparatus in which component costs or adjustment costs are reduced and a required space is suppressed by forming images of different four colors with one pair of a laser light source and a scanning polygon mirror. As show in FIG. 10A, the polygon mirror includes eight faces as reflection planes that alternately make a large tilt angle and a small tilt angle with respect to a rotation axis of the polygon mirror. The laser beam is reflected by the reflection planes having the different tilt angles in different directions. The direction of the reflected laser beam is further divided into two by using an fθ correction lens that is divided into two portions in the main-scanning direction. Thus, the laser beams in four directions are generated to expose images of the four colors. In this manner, the scanning is performed by reflecting a single laser beam with a single polygon mirror.

Japanese Patent Application Laid-open No. 2003-270581 discloses an image forming apparatus in which component costs or adjustment costs are reduced and a required space is suppressed by forming images of different four colors with one pair of a laser light source and a scanning polygon mirror. As show in FIG. 10B, the polygon mirror includes eight faces as reflection planes that alternately make a large tilt angle and a small tilt angle with respect to a rotation axis of the polygon mirror. The laser beam is reflected by the reflection planes having the different tilt angles in different direction. The fθ correction lens is first divided into two portions in the rotation-axis direction, and one of the two portions is then divided into three portions in the main-scanning direction. That is, the fθ correction lens is divided into four portions. The direction of the laser light beam is deflected in four directions. Thus, the laser beams in four directions are generated to expose images of the four colors. In this manner, the scanning is performed by reflecting a single laser beam with a single polygon mirror.

Japanese Patent Application Laid-open No. 2005-292377 discloses an image forming apparatus that obtains a high productivity by sharing a part of its components and a high image-forming speed with a low consumption power, suppressing rotation speed of the polygon mirror. As shown in FIG. 10C, the polygon mirror includes four reflection planes that are orthogonal to a bottom face of the polygon mirror that is orthogonal to the rotation axis, and four tilted reflection-planes that make a predetermined angle with the orthogonal planes. The four reflection planes and the four tilted reflection-planes are alternately arranged. The tilt of the tilted reflection-planes displaces the direction of the reflected laser beam by 4 degrees in the sub-scanning direction. Therefore, the optical path is switched in the sub-scanning direction when the laser beam enters a next reflection plane. As shown in FIG. 10D, it is allowable to use a polygon mirror including a set of four reflection planes having a tilt angle different from each other to switch the optical path from among four directions.

However, if the writing frequency increases, the consumption current also increases, which increases an unnecessary radiation and therefore increases costs. Moreover, if the polygon mirror including reflection planes having two or four types of tilt angles is used, two or four fθ correction lenses are required, which complicates the configuration and increases the costs.

### SUMMARY OF THE INVENTION

It is an object of the present invention to at least partially solve the problems in the conventional technology.

According to an aspect of the present invention, there is provided an image forming apparatus including a plurality of photosensitive image carriers; a charging unit that charges the image carriers; a light source that emits a light beam for forming an electrostatic latent image on the image carriers; a control unit that controls the light source; a polygon mirror that deflects the light beam from the light source in a main scanning direction; a developing unit that develops the electrostatic latent image formed on the image carriers with a developer to obtain a visible image; a transfer unit that transfers the visible image onto a recording medium; and a fixing unit that fixes the visible image formed on the recording medium. The polygon mirror includes four reflection planes with different tilt angles with respect to a rotation axis of the polygon mirror, and the control unit includes a correction unit that performs an fθ correction.

Furthermore, according to another aspect of the present invention, there is provided an image forming apparatus including a plurality of photosensitive image carriers; a charging unit that charges the image carriers; a light source that emits a light beam for forming an electrostatic latent image on the image carriers; a control unit that controls the light source; a polygon mirror that deflects the light beam from the light source in a main scanning direction; a developing unit that develops the electrostatic latent image formed on the image carriers with a developer to obtain a visible image; a transfer unit that transfers the visible image onto a recording medium; and a fixing unit that fixes the visible image formed on the recording medium. The polygon mirror includes five reflection planes with different tilt angles with respect to a rotation axis of the polygon mirror, one of the reflection planes is a synchronous detecting reflection plane being tilted at such a tilt angle that the light beam is input to a synchronous detecting unit, and the control unit includes a correction unit that performs an fθ correction.

Moreover according to still another aspect of the present invention, there is provided an image forming method including charging a plurality of photosensitive image carriers; deflecting a light beam emitted from a light source in a main scanning direction by a polygon mirror that includes a plurality of reflection planes with different tilt angles with respect to a rotation axis of the polygon mirror; performing an fθ correction by controlling the light source; forming an electrostatic latent image on the image carriers; developing the electrostatic latent image with a developer to obtain a visible image; transferring the visible image onto a recording medium; and fixing the visible image formed on the recording medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus according to a first embodiment of the present invention;

FIGS. 2A and 2B are schematic diagrams of a polygon mirror shown in FIG. 1 for explaining tilt angles of reflection planes;

FIG. 3 is a schematic diagram of the image forming apparatus shown in FIG. 1;

FIG. 4 is a schematic diagram for explaining an optical path between the polygon mirror and an image-forming surface of a photosensitive element shown in FIG. 1;

FIG. 5 is a graph for explaining a relation between a rotation angle of the polygon mirror and a displacement amount on the image-forming surface;

FIG. 6 is a block diagram of an image forming apparatus according to a second embodiment of the present invention;

FIG. 7 is a schematic diagram of the image forming apparatus shown in FIG. 6;

FIG. 8 is a schematic diagram of a conventional color electrophotographic apparatus;

FIG. 9 is a block diagram of the conventional color electrophotographic apparatus shown in FIG. 8; and

FIGS. 10A to 10D are perspective views of conventional polygon mirrors.

### DETAILED DESCRIPTION OF THE PREFERRED EMBODIMENTS

Exemplary embodiments of the present invention are described in detail below with reference to the accompanying drawings.

An image forming apparatus according to a first embodiment of the present invention deflects a light beam emitted from a light source in the main scanning direction by a polygon mirror, and performs an fθ correction by an ON/OFF control of the light source. The polygon mirror includes four reflection planes having a tilt angle different from each other.

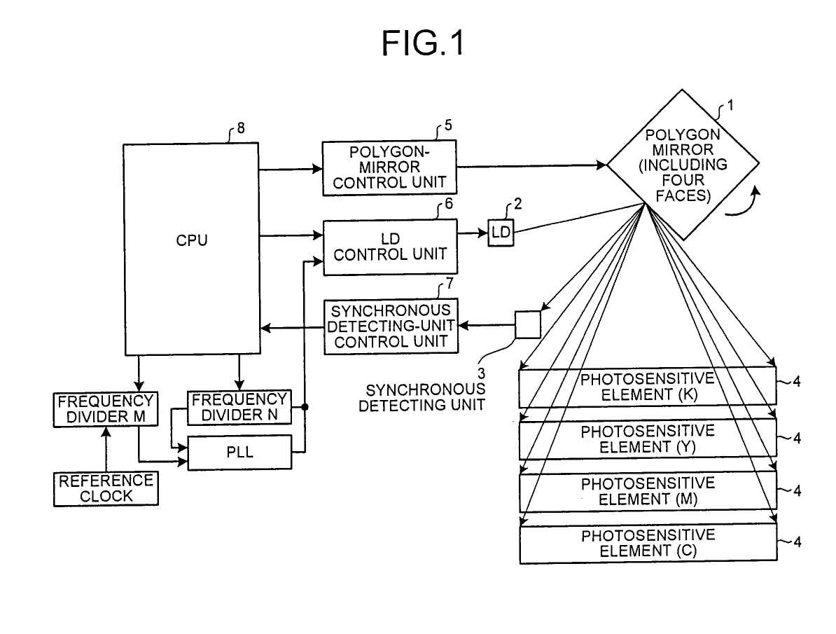

FIG. 1 is a block diagram of the image forming apparatus according to the first embodiment. As shown in FIG. 1, a polygon mirror 1 is a rotatable reflection mirror for deflecting, in the main-scanning direction, a light beam emitted from a light source. The polygon mirror 1 includes four reflection planes having a tilt angle different from each other. A laser diode (LD) 2 is a light source that emits a laser light for forming an electrostatic latent image on a charged image carrier (photosensitive element). A synchronous detecting unit 3 detects a rotating position of the polygon mirror. A plurality of photosensitive elements 4 are image carriers (photosensitive drum) on which an electrostatic latent image is formed with a laser light. The photosensitive elements 4 correspond to four colors including cyan (C), magenta (M), yellow (Y), and black (K), respectively. A polygon-mirror control unit 5 controls rotation of the polygon mirror. An LD control unit 6 controls emission of the laser light from the LD. A synchronous detecting-unit control unit 7 acquires the rotation position of the polygon mirror from a signal received from the synchronous detecting unit. A central processing unit (CPU) 8 is an arithmetic processing unit that controls units in the exposure system. The CPU 8 and the LD control unit 6 are cooperated to each other to function as an ON/OFF control unit. The ON/OFF control unit includes a correction unit for performing an fθ correction.

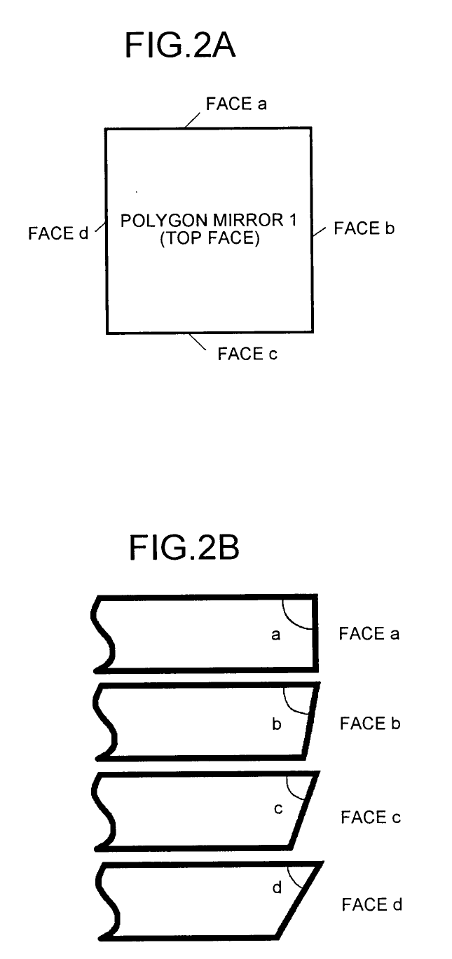

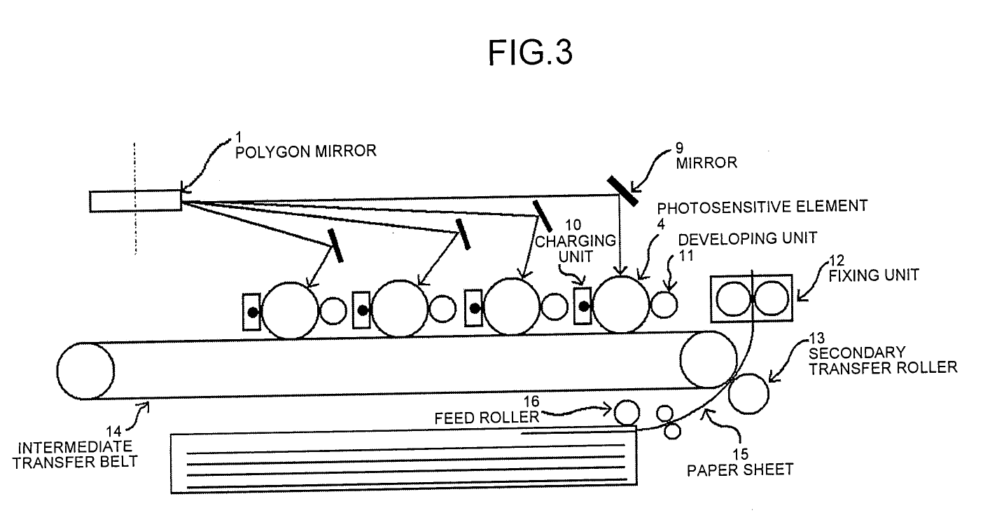

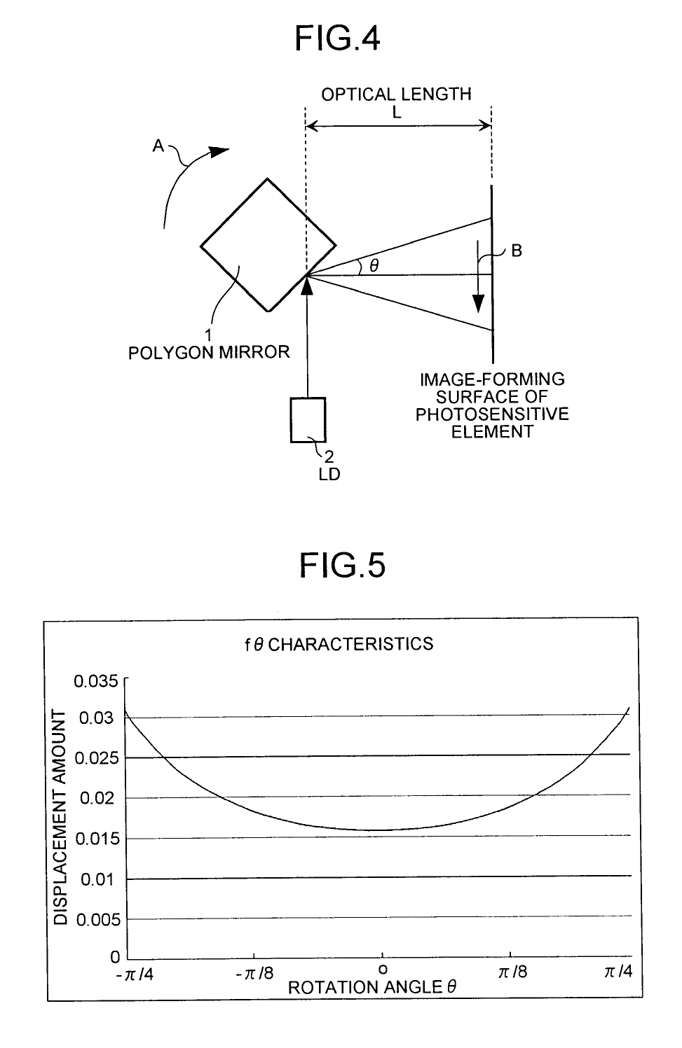

FIGS. 2A and 2B are schematic diagrams of the polygon mirror 1 for explaining tilt angles of the reflection planes. FIG. 3 is a schematic diagram of the image forming apparatus. As shown in FIG. 3, a mirror 9 is a plane mirror for reflecting a light beam received from the polygon mirror. A charging unit 10 charges the image carrier (photosensitive drum). A developing unit 11 develops the electrostatic latent image with a developer, thereby obtaining a developed image. A fixing unit 12 fixes an unfixed developer on a recording medium (paper). A secondary transfer roller 13 is an auxiliary unit that is used for transferring the developed image on an intermediate transfer belt onto the recording medium (paper). An intermediate transfer belt 14 is a transferring unit for transferring the developed image formed on the image carrier (photosensitive drum) onto the recording medium (paper). A paper sheet 15 is a printing sheet. A feed roller 16 feeds paper sheets. FIG. 4 is a schematic diagram for explaining an optical path between the polygon mirror 1 and an image-forming surface of the photosensitive element 4. FIG. 5 is a graph for explaining a relation between a rotation angle of the polygon mirror 1 and a displacement amount on the image-forming surface.

Given below is an explanation about functions and operations of the image forming apparatus according to the first embodiment. Functions are described with reference to FIG. 1. The photosensitive image carrier (photosensitive element 4) is charged by the charging unit 10. The light beam emitted from the light source (LD 2) is deflected by the polygon mirror 1 in the main-scanning direction. The four reflection planes of the polygon mirror 1 are tilted at a tilt angle different from each other. The fθ correction is performed by the correction unit of the ON/OFF control unit that control the light source (LD2). The correction unit performs the fθ correction based on a parameter depending on an optical length between the polygon mirror 1 and the photosensitive element 4. Alternatively, all of the optical lengths between the polygon mirror 1 and the image carriers (photosensitive elements 4) are adjusted to the same value by using a mirror or the like. Thus, the electrostatic latent image is formed on the charged image carrier (photosensitive element 4) with the light beam emitted from the light source (LD 2). The electrostatic latent image is developed with the developer by the developing unit 11. The developed image is transferred onto the recording medium by the intermediate transfer belt 14. The unfixed developer is fixed by the fixing unit 12 on the recording medium.

The tilt angles of the reflection planes of the polygon mirror 1 are described with reference to FIG. 2. The tilt angles, none of which is consistent, satisfy following conditions:

(Tilt angle a)>(Tilt angle b)>(Tilt angle c)>(Tilt angle d)

Therefore, when the light emitted from a single unit of the LD 2 is reflected by one of the reflection planes of the polygon mirror 1, a light path of the light is decided to one corresponding to the reflection plane that has been reflected the light beam from among four optical paths. With this configuration, a single unit of the LD 2 can scan each of the four-colored photosensitive elements 4.

Operations of the image forming apparatus are described with reference to FIG. 3. The light beam based on an image to be formed is generated by the LD 2 under control of the ON/OFF control unit. The generated light beam is subjected to the fθ correction by the control unit of the ON/OFF control unit. When the light beam emitted from the LD 2 reaches the polygon mirror 1, the light beam is reflected, depending on a color of the image to be formed, by one of the reflection planes having the tilt angle different from each other, and deflected by the rotation of the polygon mirror 1. The deflected light beam reaches a corresponding one of the mirrors 9. The corresponding mirror 9 reflects the deflected light beam to a corresponding one of the photosensitive elements 4. As a result, a latent image is formed on the photosensitive element 4. The subsequent image-forming operations are similar to the conventional image-forming operations.

The optical path between the polygon mirror 1 and the image-forming surface of the photosensitive element 4 is described with reference to FIG. 4. When the polygon mirror 1 rotates in a direction indicated by an arrow A at a constant angular velocity, the image-forming surface is raster-scanned with the light beam emitted from the LD 2 in a direction indicated by an arrow B. A relation between an image height H (exposure position on the image-forming surface) and an optical length L is as follow:

H=L×tan θ

When θ is zero, the pixel density is maximum. As an absolute value of θ increases, the pixel density decreases. If the light beam is subjected to no correction, the widths of pixels are uneven in the main scanning direction. To solve the problem, The ON/OFF control is performed.

A relation between a displacement amount in the image-forming surface and a rotation angle θ of the polygon mirror 1 is described with reference to FIG. 5. In a graph shown in FIG. 5, the rotation angle θ is an angle when the optical path L is 1, varying from −π/4 to π/4. The ON/OFF control is performed based on the displacement amount that depends on the rotation angle. More particularly, the image data is deformed in the inverse direction in such a manner that the pixel density can be even.

With the operations described above, it is possible to scan each of the four photosensitive elements by using the single LD as the light source. Moreover, there is no need for the optical face tangle error correction because one reflection plane corresponds to one photosensitive element. Furthermore, an fθ lens is not required because the fθ correction is performed by the ON/OFF control. As a result, production costs can be reduced. If the optical length between the LD and each of the photosensitive elements is different to each other, various fθ characteristics as shown in FIG. 5 are obtained depending on colors. If the fθ characteristics are different depending on colors, the fθ correction is performed by the ON/OFF control using the optical length L as a parameter. Alternatively, if the optical lengths are adjusted to the same value by using a reflection mirror or the like, the common ON/OFF control can be used.

A small-seized and lightweight polygon mirror can be used because the polygon mirror includes four reflection planes. This allows the polygon mirror to rotate at a higher rotation speed. However, a single revolution of the polygon mirror is required to raster-scan one line of one target photosensitive element. To raster-scan a plurality of lines by a single rotation of the polygon mirror, it is necessary for the polygon mirror to concurrently receive light beams from a plurality of light sources. A higher speed can be obtained by using a multi-beam LD as the light source.

In the image forming apparatus according to the first embodiment, the light beam emitted from the light source is deflected in the main scanning direction by the polygon mirror that includes four reflection planes having a tilt angle different from each other. Moreover, the fθ correction is performed by controlling ON/OFF of the light source. These allow the image forming apparatus to form a high-quality image with low costs.

An image forming apparatus according to a second embodiment of the present invention performs an fθ correction by controlling ON/OFF of a light source, and deflects a light beam emitted from the light source in the main-scanning direction by a polygon mirror. The five reflection planes have a tile angle different from each other, and a specific one of the five reflection planes is used to reflect the light beam toward a synchronous detecting unit.

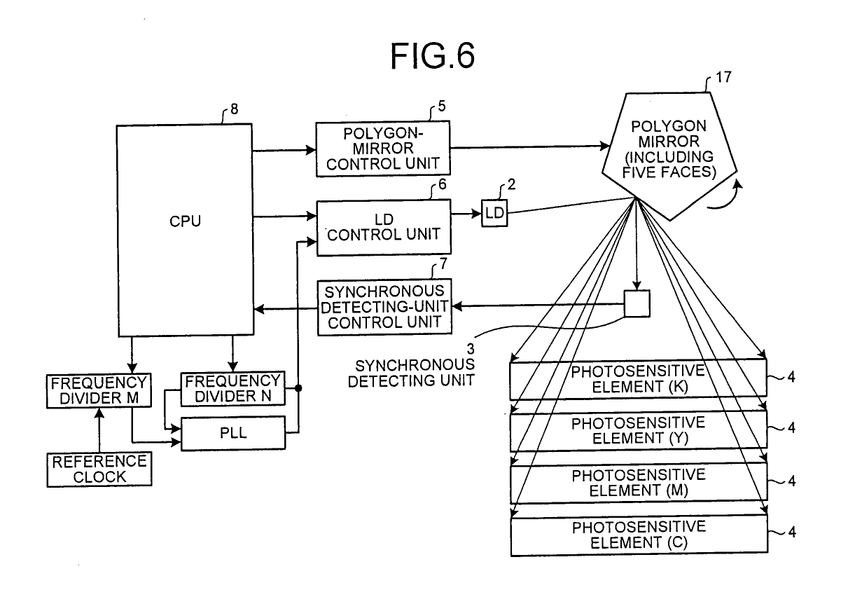

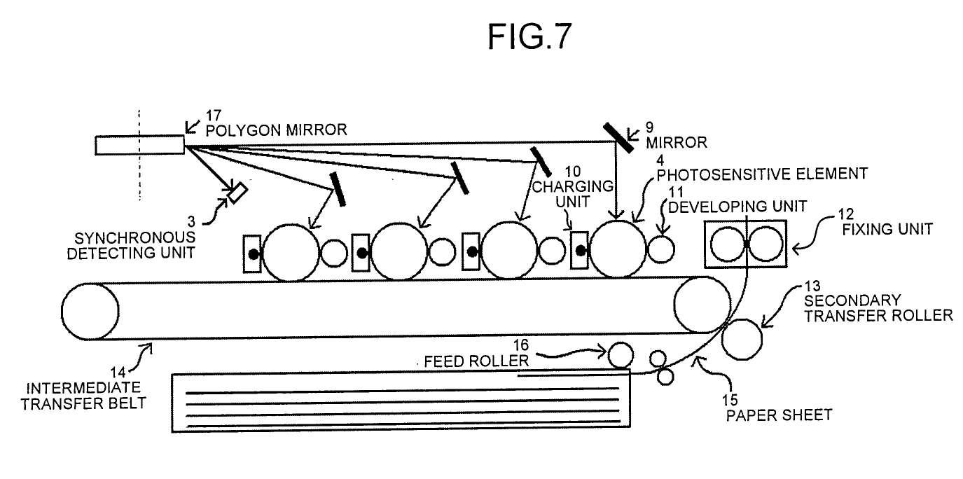

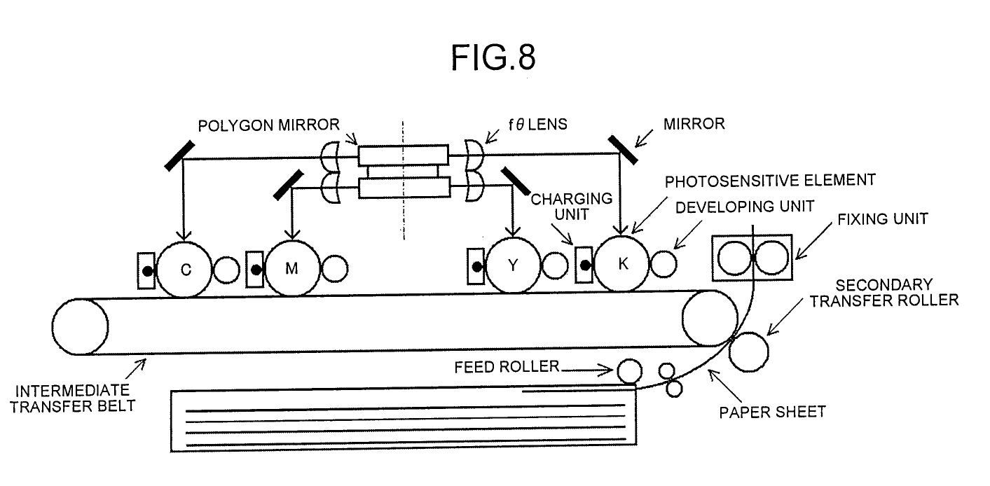

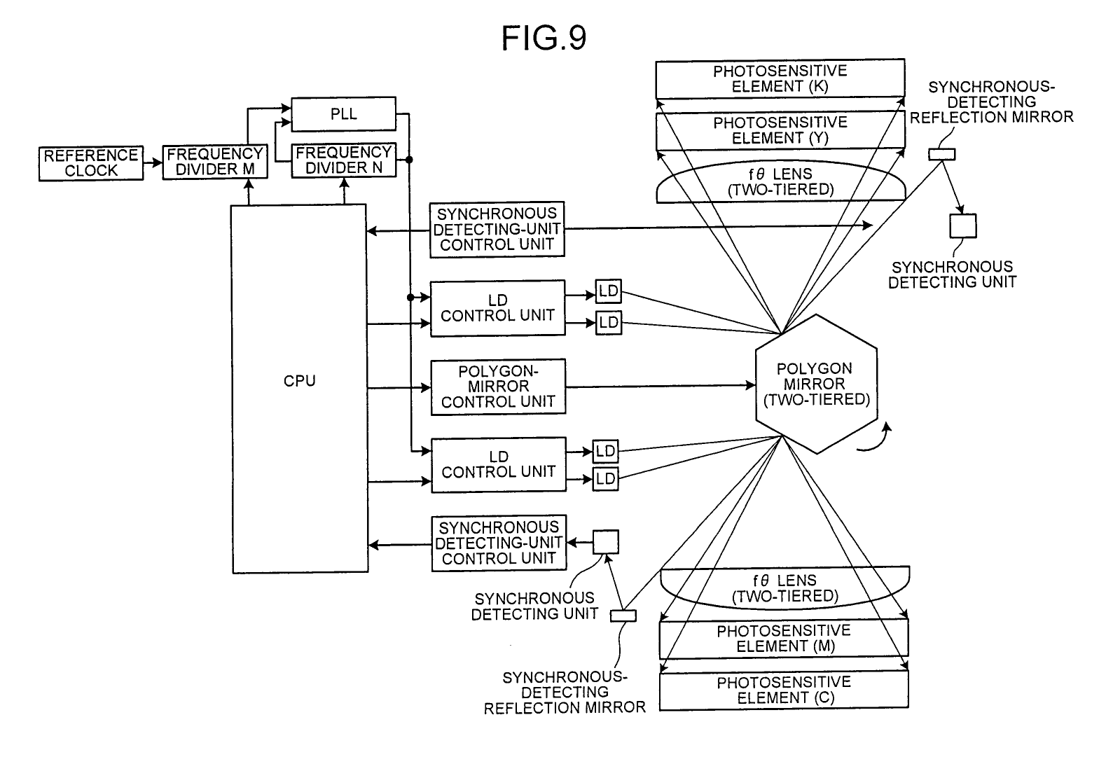

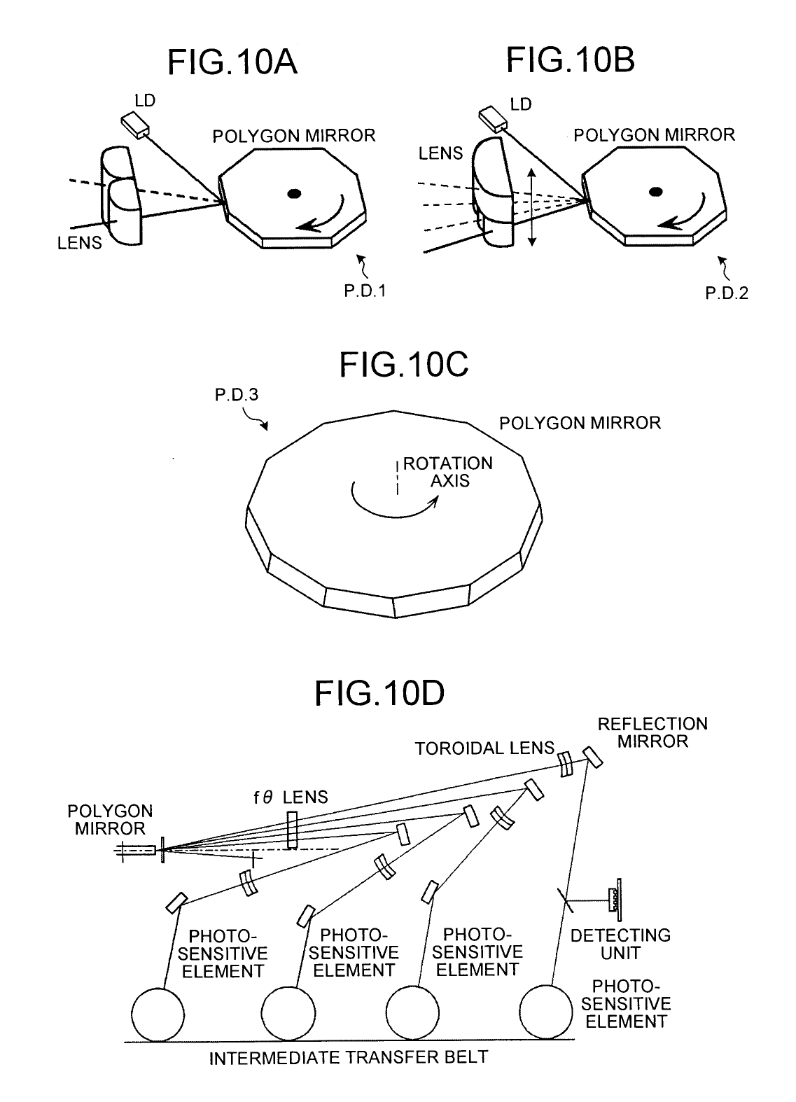

FIG. 6 is a block diagram of the image forming apparatus according to the second embodiment. The structure of the image forming apparatus according to the second embodiment is similar to the structure of the image forming apparatus according to the first embodiment except that the polygon mirror includes five reflection planes. A polygon mirror 17 includes five reflection planes that have a tilt angle different from each other. The polygon mirror 17 is a rotatable reflection mirror to deflect the light beam emitted from the light source in the main-scanning direction. FIG. 7 is a schematic diagram of the image forming apparatus.

The tilt angles of the five reflection planes are different from each other. A specific one of the five reflection planes is tilted at such a tilt angle that the light beam can reach only the synchronous detecting unit 3. For example, the tilt angles satisfy following conditions:

(Tilt angle a)>(Tilt angle b)>(Tilt angle c)>(Tilt angle d)>(Tilt angle e)

where the tilt angles a, b, c, and d are tilt angles of the reflection planes for C, M, Y, and K, respectively, and the tilt angle e is a tilt angle of the specific reflection plane for the synchronous detecting unit 3.

The optical path to the synchronous detecting unit 3 is different from the optical paths to the photosensitive elements 4. This allows increasing the effective scanning-period ratio, and thereby reducing costs. A length of the specific reflection plane can be shorter than a length of the other reflection planes because a scanning length of the synchronous detecting unit 3 can be shorter than a scanning length for image writing. For example, a pentagonal mirror in which a center angle of four planes is 85 degrees and a center angle of the remaining plane is 20 degrees can be used as the polygon mirror 17. Those configurations and operations make it possible to form a high-quality image with low costs. Moreover, the image forming apparatus can obtain a high speed by using a multi-beam LD as the light source.

As described above, according to an aspect of the present invention, it is possible to obtain an image forming apparatus that forms a high-quality image with low costs through raster-scanning using a polygon mirror.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a plurality of photosensitive image carriers;
a charging unit that charges the image carriers;
a light source that emits a light beam for forming an electrostatic latent image on the image carriers;
a control unit that controls the light source;
a polygon mirror that deflects the light beam from the light source in a main scanning direction;
a developing unit that develops the electrostatic latent image formed on the image carriers with a developer to obtain a visible image;
a transfer unit that transfers the visible image onto a recording medium; and
a fixing unit that fixes the visible image formed on the recording medium, wherein
the polygon mirror includes four reflection planes with different tilt angles with respect to a rotation axis of the polygon mirror, and
the control unit includes a correction unit that performs an fθ correction.

2. The image forming apparatus according to claim 1, wherein the correction unit performs the fθ correction based on a parameter that depends on optical lengths between the polygon mirror and the image carriers.

3. The image forming apparatus according to claim 1, further comprising an adjusting unit that adjusts optical lengths between the polygon mirror and the image carriers to a same value.

4. The image forming apparatus according to claim 1, wherein the light source includes a plurality of light emitting elements each emitting an independent light beam.

5. An image forming apparatus comprising:
a plurality of photosensitive image carriers;
a charging unit that charges the image carriers;
a light source that emits a light beam for forming an electrostatic latent image on the image carriers;
a control unit that controls the light source;
a polygon mirror that deflects the light beam from the light source in a main scanning direction;
a developing unit that develops the electrostatic latent image formed on the image carriers with a developer to obtain a visible image;
a transfer unit that transfers the visible image onto a recording medium; and
a fixing unit that fixes the visible image formed on the recording medium, wherein
the polygon mirror includes five reflection planes with different tilt angles with respect to a rotation axis of the polygon mirror,
one of the reflection planes is a synchronous detecting reflection plane being tilted at such a tilt angle that the light beam is input to a synchronous detecting unit, and
the control unit includes a correction unit that performs an fθ correction.

6. The image forming apparatus according to claim 5, wherein a width of the synchronous detecting reflection plane is shorter than widths of other reflection planes.

7. The image forming apparatus according to claim 5, wherein the correction unit performs the fθ correction based on a parameter that depends on optical lengths between the polygon mirror and the image carriers.

8. The image forming apparatus according to claim 5, further comprising an adjusting unit that adjusts optical lengths between the polygon mirror and the image carriers to a same value.

9. The image forming apparatus according to claim 5, wherein the light source includes a plurality of light emitting elements each emitting an independent light beam.

10. An image forming method comprising:
charging a plurality of photosensitive image carriers;
deflecting a light beam emitted from a light source in a main scanning direction by a polygon mirror that includes a plurality of reflection planes with different tilt angles with respect to a rotation axis of the polygon mirror;
performing an fθ correction by controlling the light source;
forming an electrostatic latent image on the image carriers;
developing the electrostatic latent image with a developer to obtain a visible image;
transferring the visible image onto a recording medium; and
fixing the visible image formed on the recording medium.

11. The image forming method according to claim 10, wherein the performing includes performing the fθ correction based on a parameter that depends on optical lengths between the polygon mirror and the image carriers.

12. The image forming method according to claim 10, further comprising adjusting optical lengths between the polygon mirror and the image carriers to a same value.

13. The image forming method according to claim 10, wherein the light source emits a plurality of light beams.
